(19) United States
(12) Patent Application Publication
(10) Pub. No.: US 2018/0144361 A1
(43) Pub. Date: May 24, 2018

(54) Vehicle odometer numbers as a marketing tool

(71) Applicant: Eftim Cesmedziev, Rancho Palos Verdes, CA (US)

(72) Inventor: Eftim Cesmedziev, Rancho Palos Verdes, CA (US)

(21) Appl. No.: 15/530,803

(22) Filed: Mar. 1, 2017

Related U.S. Application Data
(63) Continuation of application No. 62/497,561, filed on Nov. 21, 2016.

(51) Int. Cl. G06Q 30/02; H04L 29/08; G07C 5/04

(52) U.S. Cl. CPC G06Q 30/0232; H04L 67/02; G07C 5/04; G06Q 30/0276; H04L 67/12

(57) ABSTRACT

Vehicle odometer numbers used as tool that support marketing campaign is disclosed. User needs to have working vehicle with working vehicle odometer. Also, same user needs to have electronic device capable to reach a website, email sites and/or text messaging capabilities over internet or other networks. Use needs to enter its vehicle odometer number at the beginning of the driving period and then again at the end of the driving period. The software of the user's web page, emails and/or text messaging accepts all user's inputs and calculate the differences between those two numbers. As a result of the subtraction, the number is multiplied by another number given by a third party, and the final number represent user's earned point and/or money. Then user selects at least one of businesses that have links to their communication devices. Activating those links the links its account with the selected business and continue to communicate with those businesses.

### CROSS-REFERENCE TO RELATED APPLICATION

This application claims priority to U.S. Provisional Patent Application No. 62/497,561, filed Nov. 21, 2016 and entitled “Vehicle odometer numbers as a marketing tool.” The complete disclosure of the above-identified priority application is hereby fully incorporated herein by reference.

### COPYRIGHT NOTICE

A portion of the disclosure of this patent document contains material that is subject to copyright protection. The copyright owner reserves all copyrights whatsoever. The copyright owner allows the Patent and trade Office to facsimile reproduction by anyone of the patent document or the patent disclosure as is their official business practice.

### FIELD OF THE INVENTION

The present invention provides an innovative method of marketing campaign using the vehicle odometer numbers, and more particularly, using the difference in the two vehicle odometer numbers multiplied by number given by third party according the formula implemented into the software, as a tool for further marketing campaign.

### BACKGROUND OF THE INVENTION

People use their vehicles on daily basis, and travel distances that brings expenses. People use their vehicles for transportation from one point to another. When people purchase their vehicle, the value of their vehicle is going down, and the vehicle requires money for maintenance. The vehicle “takes” money from their owners, but not “earns” money.

Unfortunately, there is no platform or system where people can use their vehicle and vehicle odometer to “make” money for the vehicle user. This invention is addressing this issue.

### SUMMARY OF THE DISCLOSURE

The present invention describes method and system for marketing campaign using difference of at least two numbers of a vehicles odometer, multiplied by a number given by a third party, and all process is implemented into a website. The user of a vehicle need to have a working vehicle with working vehicle odometer, and a working computer device and/or phone with internet or other network capable to connect the world web network and is capable to reach a certain website address, email website and text messaging phone.

A workable vehicle odometer can be used as a tool for marketing campaign. The difference of at least two different numbers of the vehicle odometer can produce number, and that number can be used in the marketing campaigns. That number can represents number of points or money earned by the user of the vehicle. The user needs to be able to reach a certain website, email and/or text message page where the user needs to fill out requested information and send email and/or text it to the website administrator. When the user gave all required information to the website administrator, the user receives email or text back where the user needs to confirm its email address and/or text message as well to accept the Terms and Condition of Service and Privacy Policy if the user decides to continue with the marketing program. When user decides to continue with the program using its vehicle odometer numbers as a marketing tool, then the user needs to send email and/or text message to the website administrator that handles both options. Then the vehicle user need to use its vehicle for some time, where that time is called driving time. When the vehicle user decide to stop the driving time, the vehicle user needs to be able to reach the same website like at the beginning, where the user needs to fill out requested information and send email and/or text it to the website administrator. The difference in information between the first email and the second email that the user will send to the website administrator is the numbers entered in the field where the user needs to enter its vehicle odometer numbers. When user submits them to the website administrator, the software that is part of the website estimate the differences of the both entered odometer numbers and multiply that difference number with number given by a third party according the formulas that are already implemented in the software. When those operations are finished, the software submits the result on the user's computer screen via email message or text message, or both methods, where the user can see the information. The same message also contains links to businesses that participate in the marketing campaign. By choosing and clicking on the link of the business where the user wants to spend the earned money or points, the user automatically gives permission to the computer software to forward all email and text communication with that business. From that point on, the marketing campaign is ended and all business communication is managed between the user and the business company.

### BRIEF DESCRIPTION OF THE DRAWINGS

FIG. 1 illustrates a general presentation an example of a method and system that is embodiment and overview of the present disclosure.

On FIGS. 2.1 and 2.2 is shown example of a page that is sent to the user at the beginning of the marketing program, and this page can be part of a website, email site and/or text message design.

On FIGS. 3.1 and 3.2 is shown example of a page where user need to enter its information at the beginning of the driving period, and this page can be part of a website, email site and/or text message design.

On FIGS. 4.1 and 4.2 is shown example of a page where user need to enter its information at the end of the driving period, and this page can be part of a website, email site and/or text message design.

On FIG. 5 is show example of a page where user receive information how much money and/or point he/she earn together with links to a businesses that participate in the marketing program, and this page can be part of a website, email site and/or text message design.

### DETAILED DESCRIPTION OF THE INVENTION

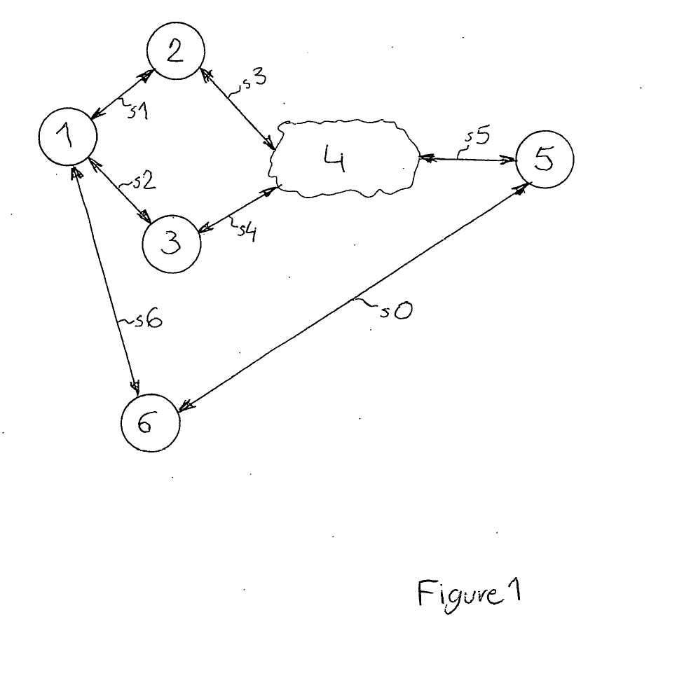

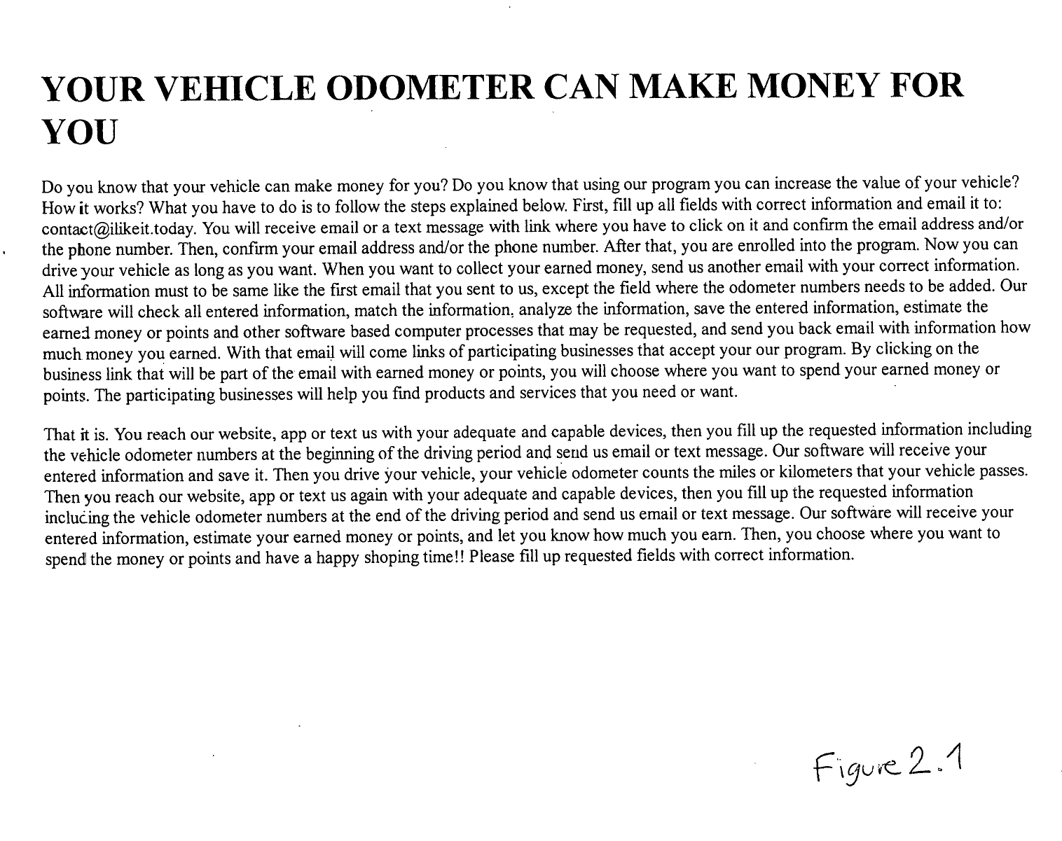

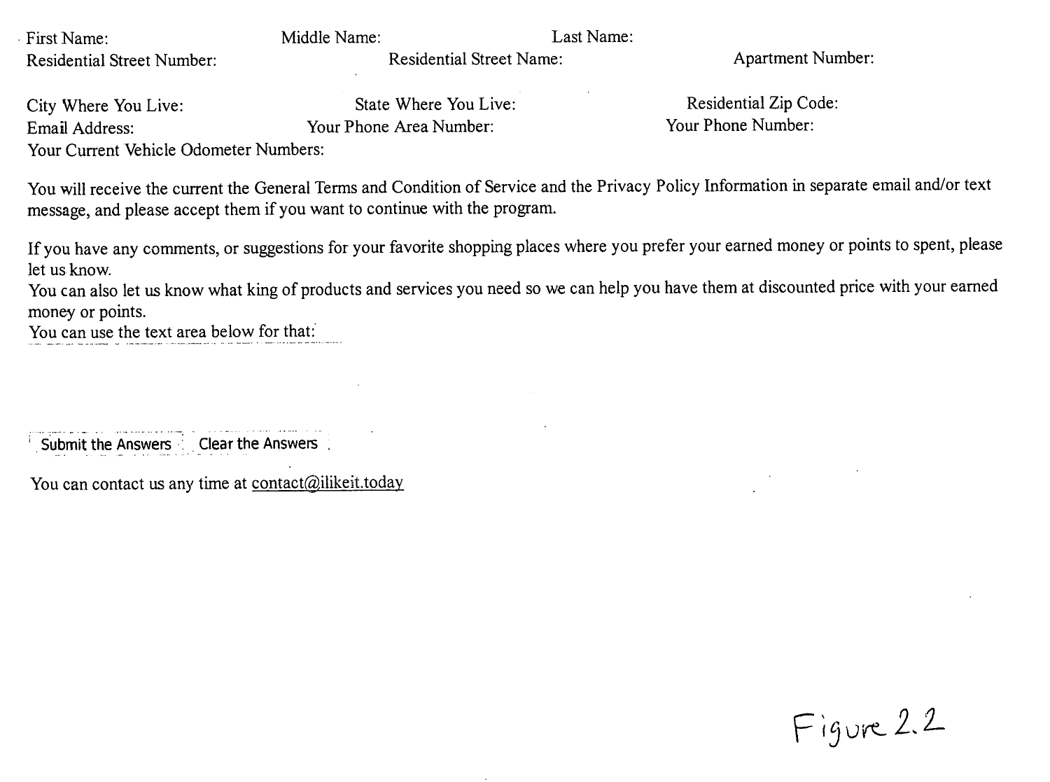

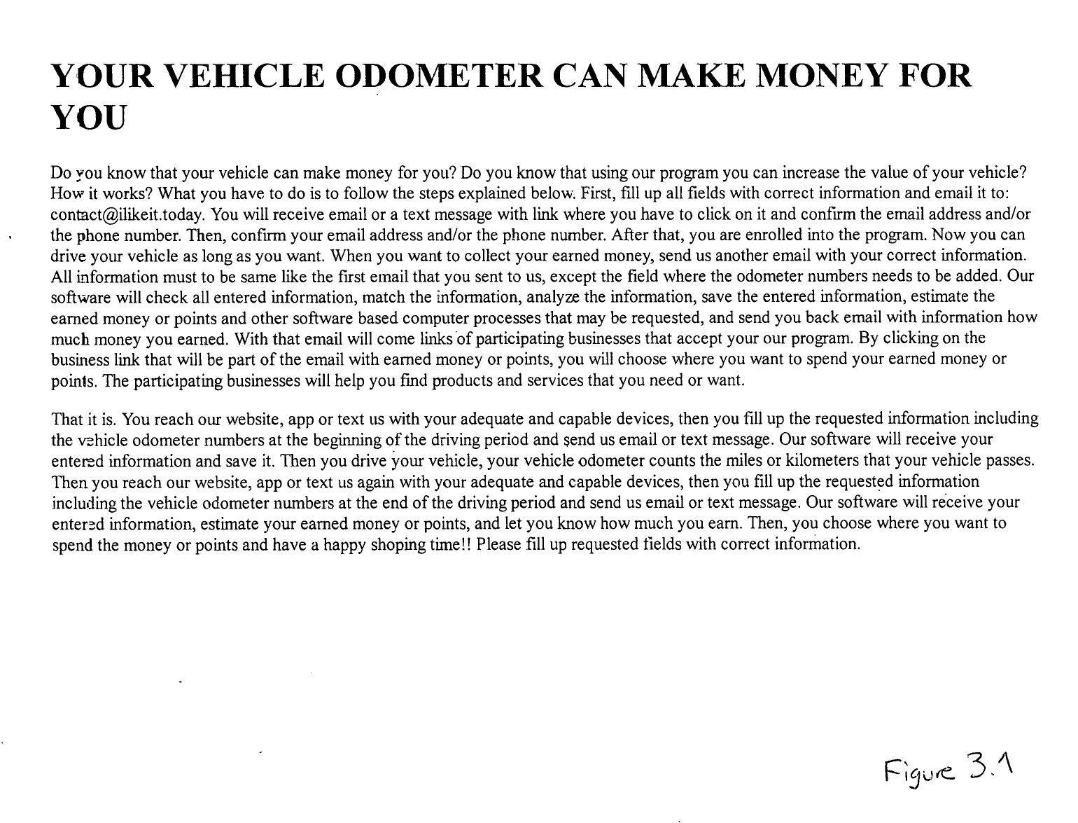

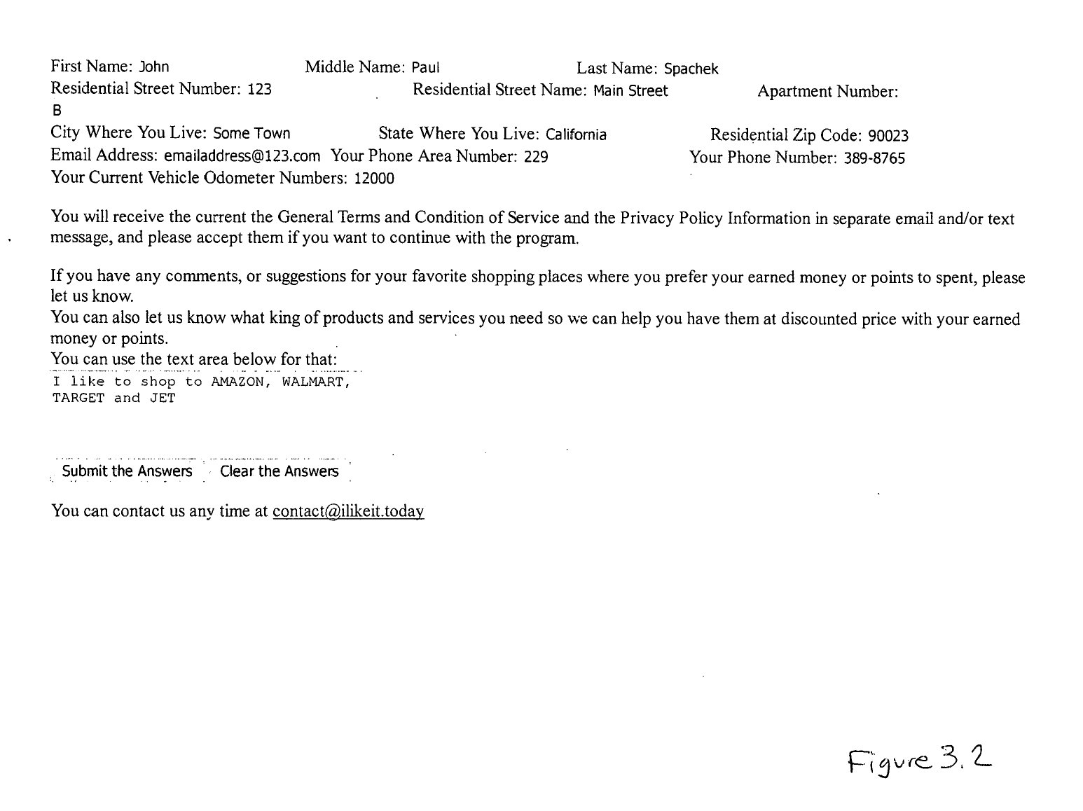

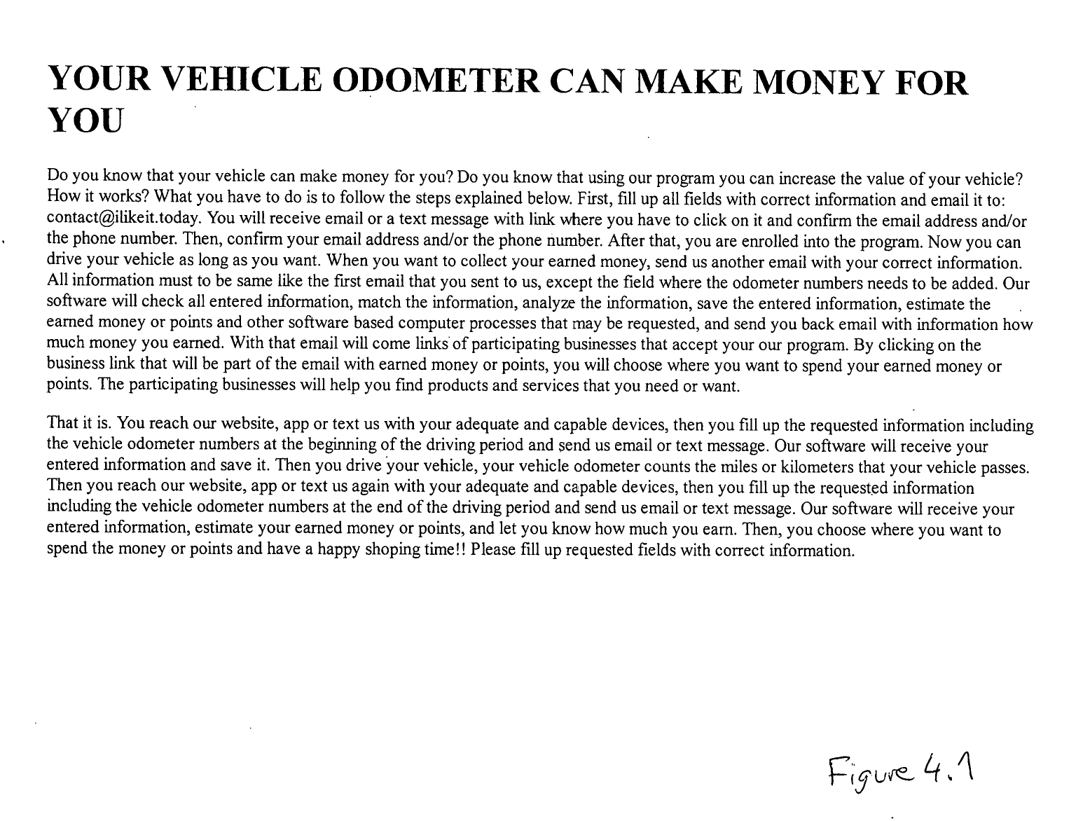

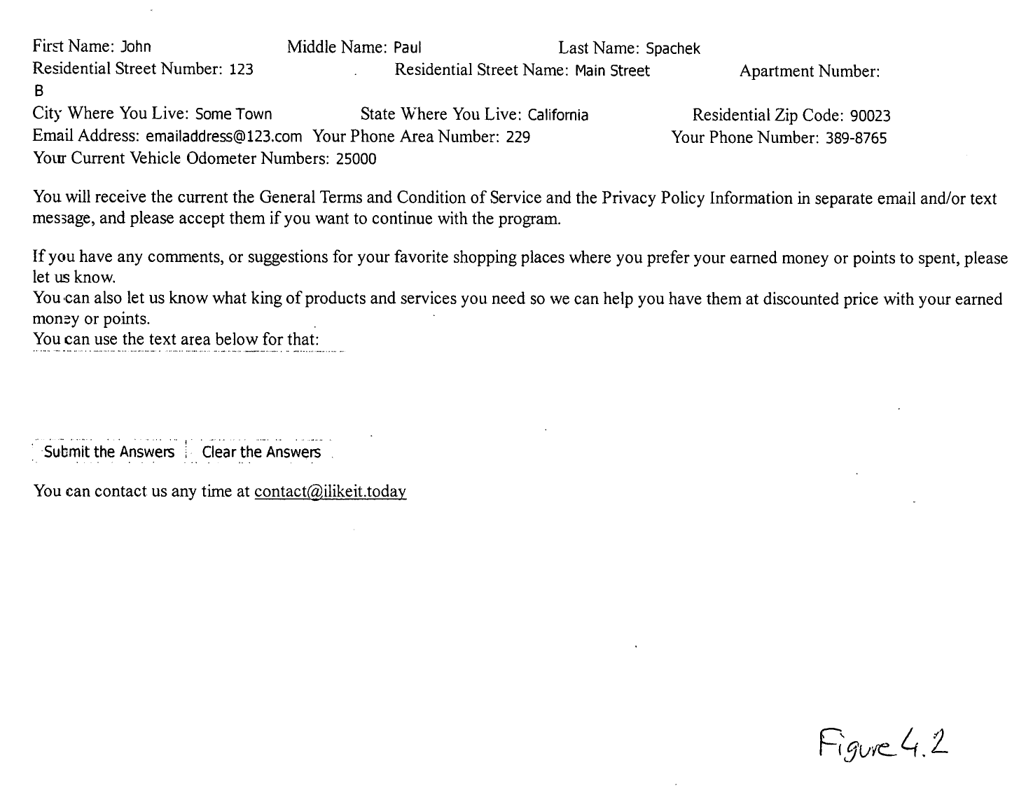

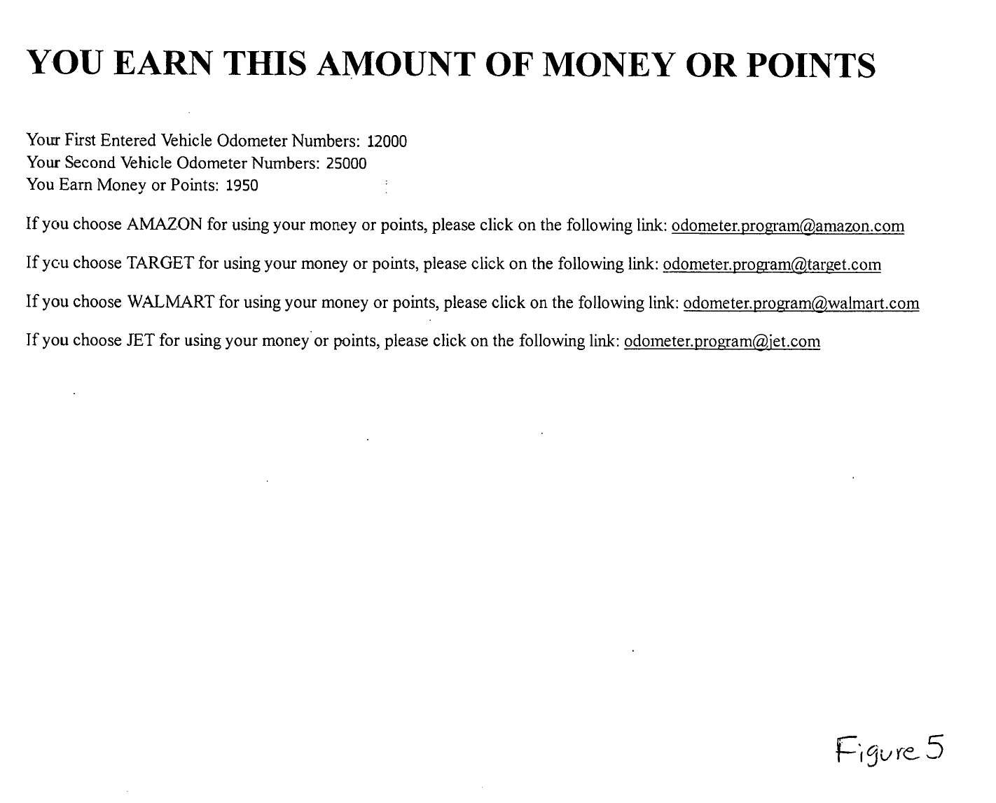

Referring now to the drawings, FIG. 1 preferably shows embodiment of the method presented in this invention and their relations. On FIG. 1, area 1 preferably represents a user of a vehicle that wants to participate in the marketing campaign. The user's vehicle has working odometer installed in the vehicle. On FIG. 1, area 2 preferably represents user's electronic device such as, but not limited to cell phones with Internet capability, computer with Internet capability, tablets with Internet capability and other devices with same or similar capabilities. On FIG. 1, area 3 preferably represents user's electronic device such as, but not limited to cell phones capable to communicate with standard telephone technology. On FIG. 1, area 4 preferably represents network, such as internet and/or phone network that are used for sending and receiving information. On FIG. 1, area 5 preferably represents a website, email site and/or text message site that are maintained by at least one website administrator. That website administrator is capable to maintain website communication, email communication as well phone communication using at least one computer software implemented in the website capable to receive, memorize, analyses, do requested operations and send information to all needed parties. On FIG. 1, area 6 preferably represents at least one business that is participating in the marketing campaign.

At the beginning of the marketing campaign the website administrator (area 5 shown on FIG. 1) communicate with various businesses and invite them to participate in the marketing campaign. Businesses that accept the invitation and sign a business contract (step 0 shown on FIG. 1) with the website administrator (area 5 shown on FIG. 1), those businesses (area 6 shown on FIG. 1) have access to all communication between the website administrator (area 5 shown on FIG. 1) and the users (area 1 shown on FIG. 1), and can communicate with the user's (area 1 shown on FIG. 1) after the marketing campaign is over.

For user to start the marketing campaign, at the beginning of the user's (area 1 shown on FIG. 1) needs to use (step 1 shown on FIG. 1) its workable electronic device (area 2 shown on FIG. 1) and/or to use (step 2 shown on FIG. 1) its workable phone device (area 3 shown on FIG. 1). With adequate use of its workable electronic device (area 2 shown on FIG. 1) and/or its workable phone device (area 3 shown on FIG. 1), a user (area 1 shown on FIG. 1) needs successfully to reach (step 3 and/or step 4 shown on FIG. 1) a computer and/or phone network (area 4 shown on FIG. 1) that send (step 5 shown on FIG. 1) successfully all information to the website administrator (area 5 shown on FIG. 1). Then, the website (area 5 shown on FIG. 1) automatically send to the user (area 1 shown on FIG. 1) form (FIGS. 2.1 and 2.2) that needs to be filled out, using back the same path of communication (same network and the device that user use it at the beginning).

Upon receiving the form (FIGS. 2.1 and 2.2), the user (area 1 shown on FIG. 1) need to fill out all requesting information (FIG. 2.2). Some of the requesting information that the website administrator (area 5 shown on FIG. 1) may requests are, but not limited to, the vehicle current odometer numbers at the beginning of the driving period, personal information about the user, such as residential address, email address, phone number, and the like. When all requests are filled out (FIG. 3.2) by the user (area 1 shown on FIG. 1), then the user (area 1 shown on FIG. 1) need to send back the form (FIGS. 3.1 and 3.2) to the website administrator (area 5 shown on FIG. 1) using the same path of communication.

The website (area 5 shown on FIG. 1) contains at least one software capable to accept the user's (area 1 shown on FIG. 1) inputs of information, check it for mistakes, record the information, time, date and location, and memorize it into the memory.

When the process of entering the user's (area 1 shown on FIG. 1) input is successfully finished, the website software send back (not shown) information to the use with confirming information of successfully received the user's input. The information that the website software (area 5 shown on FIG. 1) send back to the user, can be viewed on the user's (area 1 shown on FIG. 1) workable electronic device monitor. Then, the user (area 1 shown on FIG. 1) can start its driving period. While the user (area 1 shown on FIG. 1) drive its vehicle, the vehicle odometer records every mile (in some countries is kilometers) that the vehicle passes, and the numbers that are shown on the vehicle odometer are changing according the miles/kilometers that vehicle.

The driving period is defined as a time when user drives its vehicle while numbers of the vehicle odometer are changing with greater numerical values. The beginning of the driving period is when user (area 1 shown on FIG. 1) successfully enter the numbers shown on the vehicle odometer into the form (FIG. 2.2) that the website administrator (area 5 shown on FIG. 1), fill out all requested information (FIG. 3.2) and send back to the website administrator (area 5 shown on FIG. 1) as an email and/or text message. The end of the driving period is when user (area 1 shown on FIG. 1) successfully enter the numbers shown on the vehicle odometer into the form (FIG. 2.2) that the website administrator (area 5 shown on FIG. 1) sent it to the user, fill out all requested information (FIG. 4.2) and send back to the website administrator (area 5 shown on FIG. 1) as an email and/or text message. The difference of the information that user (area 1 shown on FIG. 1) sends to the website administrator (area 5 shown on FIG. 1) at the beginning of the driving period and at the end of the driving period is, the numbers entered into the odometer number field, where the odometer numbers entered at the end of the driving period (FIG. 4.2) must be with higher value that the odometer numbers entered at the beginning of the driving period (FIG. 3.2). Rest of the information is same.

The website (area 5 shown on FIG. 1) contains at least one software capable to accept the user's (area 1 shown on FIG. 1) inputs, remember the user's input and save the user's input on the memory device, check it for mistakes, record the time, date and location, and memorize it into the memory device. The website software (area 5 shown on FIG. 1) is programmed to accept those numbers, check for accuracy, save them, do multiple of function, including but not limited to mathematical process that subtract the entered second set (FIG. 4.2) of entered numbers of the user's vehicle odometer from the entered first set (FIG. 3.2) of entered numbers of the user's vehicle odometer reading, to estimate the difference between them, and to multiply that difference number with number given by a third party according the formulas that are already implemented in the software.

The main formula that the software is using for estimating the earned money or points is:

(B−A)×C=number that represents earned points and/or money

where:
B represents the user's vehicle odometer numbers at the end (FIG. 4.2) of the driving period;
A represents the user's vehicle odometer numbers at the beginning (FIG. 3.2) of the driving period;
C represents the number given by a third party, usually website administrator or participating business representative.

The result may represents points and/or money that the user earn them while driving its vehicle. Those points and/or money can be used at least at one of the participating businesses (area 6 shown on FIG. 1). The user (area 1 shown on FIG. 1) will receive information how much money and/or points earn with links to participation businesses where the user can spend the earned money and/or points (FIG. 5). The user (area 1 shown on FIG. 1) needs to activate one of those links that links to the businesses (FIG. 5) devices used for communication. By activating one of those business links (FIG. 5), the website (area 5 shown on FIG. 1) software will connect (step 6 shown on FIG. 1) the user (area 1 shown on FIG. 1) with that business (area 6 shown on FIG. 1). By choosing and clicking on the link (FIG. 5) of the business (area 6 shown on FIG. 1) where the user (area 1 shown on FIG. 1) wants to spend the earned money or points, the user (area 1 shown on FIG. 1) automatically gives permission to the website computer software (area 5 shown on FIG. 1) to forward all email and/or text communication with that business (area 6 shown on FIG. 1). From that point on, the marketing campaign is ended and all business matters are managed between the user (area 1 shown on FIG. 1) and the business company (area 6 shown on FIG. 1).

The invention claimed is:

1. A method of using user's vehicle odometer numbers as a tool for marketing campaign, said method comprising:
a) at least one user have working vehicle with working vehicle odometer, and same user have at least one electronic device capable to be connected with at least one website software over internet, and/or at least on application software installed into the user's electronic device, and/or at least one mobile application software installed into the user's electronic device, and/or at least one social network software installed into the user's electronic device, and/or at least one email software, and/or at least one telephone application software installed into a cell phone capable to make phone calls; then
b) at least one user use at least one electronic device that have at least one memory hardware coupled to at least one processor hardware; then
c) at least one user use at least one electronic device capable to be connected with at least one website software over internet, and/or at least on application software installed into the user's electronic device, and/or at least one mobile application software installed into the user's electronic device, and/or at least one social network software installed into the user's electronic device, and/or at least one email software, and/or at least one telephone application software installed into a cell phone capable to make phone calls; then
d) when at least one user's electronic device is connected to at least one website software, and/or at least one application software, and/or at least one mobile application software, and/or at least one social network software, and/or at least one email software, and/or at least on telephone software capable to make telephone calls, the user connects its device with URL of at least one website software, and/or at least one application software, and/or at least one mobile application software, and/or at least one social network software, by at least one processor of the user's electronic device over internet, and/or at least one email software and/or at least one telephone application software installed into a cell phone capable to make phone calls; then
e) at least one computer server that have installed at least one software, and at least one memory hardware coupled to at least one computer processor that housing at least one website software, and/or at least one application software, and/or at least one mobile application software, and/or at least one social network software, and/or at least one email software, and/or at least one telephone application software installed into a cell phone capable to make phone calls, receives over the internet and/or other network request sent to become member by a user's electronic device, wherein the software that is executed by at least one processor of at least one website software, and/or at least one application software, and/or at least one mobile application software, and/or at least one social network software, and/or at least one email account software, and/or at least one telephone application software installed into a cell phone capable to make phone calls, is configured to:
1) link the user's electronic device with the entered URL address over internet upon entering the correct URL address by the user into the correct area using its electronic device; or link the user's telephone device with the certain telephone number over network upon entering the correct phone number by the user into the correct area using its electronic device;
2) receiving user's requests, provide user with marketing campaign information and all other information on user's electronic device monitor for viewing;
3) receiving information sent by the user;
4) providing the user with designed web page, such as but not limited to web page, email page, text page, forms, surveys, and the like, functionally connected together with database;
5) receiving user's database and linking it with the user's email address and/or text address requesting confirmation of the user's database;
6) receiving user's confirmation database;
7) providing the user with plurality of forms linked together, where those plurality of forms are part of the website software, and/or at least one application software, and/or at least one mobile application software, and/or at least one social network software, and/or at least email account software, and/or at least one telephone application software installed into a cell phone capable to make phone calls;
8) providing plurality of forms functionally connected together with content;
9) providing plurality of forms functionally connected together with content and sent them over the internet or other network to the user's electronic device monitor for viewing;
11) providing web page, email and/or text with graphic designed forms for user-to enter its database information;
12) receiving user's web message, email message and/or text message in database information and check it for accuracy;
13) provide user with information if the web message, email message and/or text message database entered are not correct until user enter the correct database information that match the database information stored in the memory;
14) provide user with web page, email and/or text message that contains information about the marketing campaign process;
15) receiving the first set of vehicle odometer numbers entered into the designated graphic area by the user at the beginning of the driving period together with other user's information via email, web page and/or text message;
16) receiving, checking and memorizing the entered information by the user;
17) providing user with confirmation of successfully entered database;
18) remembering entered information, the time, date and location when user entered its information and storing it;
19) provide user with plurality of forms again that are functionally connected together with content entered from the previous communications, check if the entered information matches with the previous communication, and do that until user enter the correct database information that match the information stored in the memory;
20) providing user again with plurality of forms functionally connected together with content and sent them over the internet or other network to the user's electronic device monitor for viewing;
21) providing again web page, email and/or text with graphic designed forms for user to enter its database information;
22) receiving again user's web page, email message and/or text message in database information and check it for accuracy;
23) provide again user with information if the web page, email message and/or text message database entered are not correct until user enter the correct database information that match the database information stored in the memory;
24) receiving the second set of vehicle odometer numbers entered into the designated graphic area by the user at the end of the driving period together with other user's information via email, web page and/or text message;
25) receiving, checking and memorizing again the entered information by the user;
26) providing user again with confirmation of successfully entered database;
27) remembering again entered information, the time, date and location when user entered its information and storing it;
28) perform mathematical tasks such as, but not limited to, act of subtracting of entered second set of vehicle odometer database by the user from entered first set of vehicle odometer database by the user, and the result of that subtract operation is a positive numerical value, where that positive numerical value is multiplied by pluralities of numbers given by a third party, and at the end of those mathematical processes result is a positive set of numbers database;
29) providing user with the result of the mathematical process, which is the positive set of numbers database and information about the result on a user's electronic device monitor for viewing;
30) providing user web page, email page and/or text message with information, such as but not limited to, how much money and/or points user earned, link that links user's account with at least one business that participate in the marketing campaign, and requesting from the user to activate at least one of the links;
31) receiving information from the business link that the user activate their link;
32) linking user's electronic device with business electronic database information over internet or other network;
33) memorize and store all user's database, as well business database.

2. The method of claim 1, wherein said user further comprising person that has workable vehicle with workable vehicle odometer installed into the vehicle, and is willing and capable to become member of at least one website software over internet, and/or at least on application software, and/or at least one mobile application software, and/or at least one social network software, and/or at least email account software, and/or at least one telephone application software installed into a cell phone capable to make phone calls.

3. The method of claim 1, wherein said vehicle odometer numbers further comprising numbers that the vehicle odometer are showing, where those numbers represents miles or kilometers that the vehicle pass.

4. The method of claim 1, wherein said marketing campaign further comprising series of activities used by marketing industry in order to increase awareness for particular business and business products and services, as well to connect people with those businesses.

5. The method of claim 1, wherein said electronic device further comprising any kind of electronic device such as, but not limited to cell phone, desktop computer, laptop computer, tablets, watches, and the like, where those electronic devices have devices capable to connect with the worldwide system of interconnected computer networks that use the internet protocol suite to link plurality of devices worldwide and/or telephone network capable for cell phone to make calls.

6. The method of claim 1, wherein said designated area further comprising virtual designated location that is controlled by the web pages software, email software and/or telephone software, and that software is capable to accept user's input of the odometer's numbers, memorize it, save it and use it for all needed processes given by the software.

7. The method of claim 1, wherein said first set of numbers of the vehicle odometer further comprising set of numbers shown on the user's vehicle odometer before the start of the driving period, and user must to duplicate exact same numbers that are shown on the vehicle odometer and place them to the requested area shown on the user's web page, email page and/or text messaging page.

8. The method of claim 1, wherein said driving period further comprising time that user is using for driving its vehicle, where the driving period starts when user successfully enter the first set of numbers shown on the user's vehicle odometer before the start of the driving period into the designated area shown on the user's web page, email page and/or text message page and send it to the website administrator; and the driving period ends when user successfully enter the second set of numbers shown on the user's vehicle odometer into the designated area shown on the user's web page, email page and/or text message page and send it to the website administrator.

9. The method of claim 1, wherein said second set of numbers of the vehicle odometer further comprising set of numbers shown on the user's vehicle odometer after the driving period, and user must to duplicate exact same numbers that are shown on the vehicle odometer and place them to the designated area shown on the user's web page, email page and/or text message page.

10. The method of claim 1, wherein said software further comprising organized collection of computers data and instructions capable to: (i) connect computer hardware devices and/or telephone hardware devices in one working unit; (ii) enable at least one electronic device to communicate with the operating system, with users, with internet and/or other network, with number of applications, and (iii) to accomplish specific tasks, such as but not limited to do mathematical tasks, such as subtracting one sets of number from another set of number, and the result of the subtracting process to multiply with at least one set of number.

11. The method of claim 1, wherein said result further comprising numerical information shown on a designated area on the user's webpage, email page and/or text page, where the same numerical information is result of the mathematical process performed and accomplished by a software, and presented on at least user's electronic device monitor for viewing.

12. The method of claim 1, wherein said formula further comprising at least one formula, such as but not limited to formula that the personalized and secure user's set of web pages software is using is:
(B−A)×C=number that represents earned points and/or money
where:
B represents the user's vehicle odometer numbers at the end of the driving period;
A represents the user's vehicle odometer numbers at the beginning of the driving period;
C represents the number given by a third party, usually website administrator or participating business representative;
the formula is subtracting higher entered vehicle odometer number (B) from lower entered vehicle odometer number (A), and the result of that subtraction is multiplied by another number (C) given by a third party, and the result is number that shows how much points and/or money user earned.

13. The method of claim 1, wherein said result further comprising information that the website administrator send to the user's device with monitor, where user can see how much money and/or point he/she earn.

14. The method of claim 1, wherein said businesses further comprising businesses that are linked to at least one of the user's web page, email page and/or text page, where businesses are represented by a link or in other way as the business choose it.

15. The method of claim 1, wherein said link further comprising business represented by a logo, website link or in other way as the business choose it, where the web page/website software, email software and/or text message software uses that business link as a link between the user's account and the business when the user activate the business link; when user activate the business link by clicking on it, the web page/website software, email software and/or text message software share needed user's information with that business, such as but not limited to user's name, user's physical address, user's mailing address, user's preferences, and other user's personal information.

16. A system of using user's vehicle odometer numbers as a tool for marketing campaign, said system comprising at least one memory that is operatively coupled with at least one computer processor and/or cell phone processor, wherein at least one memory having instructions stored thereon, is configured when executed by at least one processor to:
1) link the user's electronic device with the entered URL address over internet upon entering the correct URL address by the user into the correct area using its electronic device; or link the user's telephone device with the certain telephone number over network upon entering the correct phone number by the user into the correct area using its electronic device;
2) receiving user's requests, provide user with marketing campaign information and all other information on user's electronic device monitor for viewing;
3) receiving information sent by the user;
4) providing the user with designed web page, such as but not limited to web page, email page, text page, forms, surveys, and the like, functionally connected together with database;
5) receiving user's database and linking it with the user's email address and/or text address requesting confirmation of the user's database;
6) receiving user's confirmation database;
7) providing the user with plurality of forms linked together, where those plurality of forms are part of the website software, and/or at least one application software, and/or at least one mobile application software, and/or at least one social network software, and/or at least email account software, and/or at least one telephone application software installed into a cell phone capable to make phone calls;
8) providing plurality of forms functionally connected together with content;
9) providing plurality of forms functionally connected together with content and sent them over the internet or other network to the user's electronic device monitor for viewing;
11) providing web page, email and/or text with graphic designed forms for user to enter its database information;
12) receiving user's web message, email message and/or text message in database information and check it for accuracy;
13) provide user with information if the web message, email message and/or text message database entered are not correct until user enter the correct database information that match the database information stored in the memory;
14) provide user with web page, email and/or text message that contains information about the marketing campaign process;
15) receiving the first set of vehicle odometer numbers entered into the designated graphic area by the user at the beginning of the driving period together with other user's information via email, web page and/or text message;
16) receiving, checking and memorizing the entered information by the user;
17) providing user with confirmation of successfully entered database;
18) remembering entered information, the time, date and location when user entered its information and storing it;
19) provide user with plurality of forms again that are functionally connected together with content entered from the previous communications, check if the entered information matches with the previous communication, and do that until user enter the correct database information that match the information stored in the memory;
20) providing user again with plurality of forms functionally connected together with content and sent them over the internet or other network to the user's electronic device monitor for viewing;
21) providing again web page, email and/or text with graphic designed forms for user to enter its database information;
22) receiving again user's web page, email message and/or text message in database information and check it for accuracy;
23) provide again user with information if the web page, email message and/or text message database entered are not correct until user enter the correct database information that match the database information stored in the memory;
24) receiving the second set of vehicle odometer numbers entered into the designated graphic area by the user at the end of the driving period together with other user's information via email, web page and/or text message;
25) receiving, checking and memorizing again the entered information by the user;
26) providing user again with confirmation of successfully entered database;
27) remembering again entered information, the time, date and location when user entered its information and storing it;
28) perform mathematical tasks such as, but not limited to, act of subtracting of entered second set of vehicle odometer database by the user from entered first set of vehicle odometer database by the user, and the result of that subtract operation is a positive numerical value, where that positive numerical value is multiplied by pluralities of numbers given by a third party, and at the end of those mathematical processes result is a positive set of numbers database;
29) providing user with the result of the mathematical process, which is the positive set of numbers database and information about the result on a user's electronic device monitor for viewing;
30) providing user web page, email page and/or text message with information, such as but not limited to, how much money and/or points user earned, link that links user's account with at least one business that participate in the marketing campaign, and requesting from the user to activate at least one of the links;
31) receiving information from the business link that the user activate their link;
32) linking user's electronic device with business electronic database information over internet or other network;
33) memorize and store all user's database, as well business database.

17. A system of using user's vehicle odometer numbers as a tool for marketing campaign, said system further comprising:
a) user that has working vehicle with working vehicle odometer, and same user have at least one electronic device capable to be connected over internet or other networks and capable to reach a website, email site and/of text site over internet or other networks;
b) at least one user's electronic device with monitor for viewing information;
c) at least one computer software embodied on an electronic device readable non-transitory medium capable of executing program code;
d) at least one memory coupled with at least one processor that has at least one software program capable to execute the computer and/or phone to: receive all entered information by the user or third party; determination if the entered information is correct; calculate selected information according preselected formula; generate result that can be used in a further marketing campaign;
e) at least one program code capable to execute at least one processor causing the computer to house a website with plurality of web pages, and/or email account with plurality of emails, and/or cell phone capable of receiving and sending text messages; to create personal and secure set of web pages for every user under the website, and/or user's personal email account, and/or user personal text message account; to accept all entries by the user from the user's set of web pages, user's email account and/or user's text messaging account; to collect, analyze and store all user's inputs; to calculate selected information according formula given by software administrator; to show all numerical and word result information from the calculation on at least one user's electronic device with monitor; to share user's personal information with third parties when user agree for that when user activate at least one business link that link the user's account with the selected business; to automatically logout user from its set of web pages when user decide to continue communication with the selected business, and from its email account and/or text messaging account.

18. At least one non-transitory computer readable medium having computer readable instructions stored thereon that, when upon is executed by at least one computing device, cause at least one computing device to:
1) link the user's electronic device with the entered URL address over internet upon entering the correct URL address by the user into the correct area using its electronic device; or link the user's telephone device with the certain telephone number over network upon entering the correct phone number by the user into the correct area using its electronic device;
2) receiving user's requests, provide user with marketing campaign information and all other information on user's electronic device monitor for viewing;
3) receiving information sent by the user;
4) providing the user with designed web page, such as but not limited to web page, email page, text page, forms, surveys, and the like, functionally connected together with database;
5) receiving user's database and linking it with the user's email address and/or text address requesting confirmation of the user's database;
6) receiving user's confirmation database;
7) providing the user with plurality of forms linked together, where those plurality of forms are part of the website software, and/or at least one application software, and/or at least one mobile application software, and/or at least one social network software, and/or at least email account software, and/or at least one telephone application software installed into a cell phone capable to make phone calls;
8) providing plurality of forms functionally connected together with content;
9) providing plurality of forms functionally connected together with content and sent them over the internet or other network to the user's electronic device monitor for viewing;
11) providing web page, email and/or text with graphic designed forms for user to enter its database information;
12) receiving user's web message, email message and/or text message in database information and check it for accuracy;
13) provide user with information if the web message, email message and/or text message database entered are not correct until user enter the correct database information that match the database information stored in the memory;
14) provide user with web page, email and/or text message that contains information about the marketing campaign process;
15) receiving the first set of vehicle odometer numbers entered into the designated graphic area by the user at the beginning of the driving period together with other user's information via email, web page and/or text message;
16) receiving, checking and memorizing the entered information by the user;
17) providing user with confirmation of successfully entered database;
18) remembering entered information, the time, date and location when user entered its information and storing it;
19) provide user with plurality of forms again that are functionally connected together with content entered from the previous communications, check if the entered information matches with the previous communication, and do that until user enter the correct database information that match the information stored in the memory;
20) providing user again with plurality of forms functionally connected together with content and sent them over the internet or other network to the user's electronic device monitor for viewing;
21) providing again web page, email and/or text with graphic designed forms for user to enter its database information;
22) receiving again user's web page, email message and/or text message in database information and check it for accuracy;
23) provide again user with information if the web page, email message and/or text message database entered are not correct until user enter the correct database information that match the database information stored in the memory;
24) receiving the second set of vehicle odometer numbers entered into the designated graphic area by the user at the end of the driving period together with other user's information via email, web page and/or text message;
25) receiving, checking and memorizing again the entered information by the user;
26) providing user again with confirmation of successfully entered database;
27) remembering again entered information, the time, date and location when user entered its information and storing it;
28) perform mathematical tasks such as, but not limited to, act of subtracting of entered second set of vehicle odometer database by the user from entered first set of vehicle odometer database by the user, and the result of that subtract operation is a positive numerical value, where that positive numerical value is multiplied by pluralities of numbers given by a third party, and at the end of those mathematical processes result is a positive set of numbers database;
29) providing user with the result of the mathematical process, which is the positive set of numbers database and information about the result on a user's electronic device monitor for viewing;
30) providing user web page, email page and/or text message with information, such as but not limited to, how much money and/or points user earned, link that links user's account with at least one business that participate in the marketing campaign, and requesting from the user to activate at least one of the links;
31) receiving information from the business link that the user activate their link;
32) linking user's electronic device with business electronic database information over internet or other network;
33) memorize and store all user's database, as well business database.
